(19) United States
(12) Patent Application Publication
(10) Pub. No.: US 2015/0067567 A1
(43) Pub. Date: Mar. 5, 2015

(54) SYSTEM AND METHOD FOR PROVIDING INFORMATION ON A MOBILE MACHINE

(71) Applicant: Reichhardt GmbH Steuerungstechnik, Hungen (DE)

(72) Inventor: Andreas LANGSDORF, Muenzenberg (DE)

(73) Assignee: REICHHARDT GMBH STEUERUNGSTECHNIK, Hungen (DE)

(21) Appl. No.: 14/340,625

(22) Filed: Jul. 25, 2014

(30) Foreign Application Priority Data
Aug. 30, 2013 (DE) 10 2013 109 444.9

(51) Int. Cl. G06F 3/0484

(52) U.S. Cl. CPC G06F 3/0484
USPC 715/771

(57) ABSTRACT

A system for providing machine-specific information on a mobile machine which includes a programmable electronic control device and an associated user interface includes a command input mechanism and a graphic display panel, the control device and/or the user interface having implemented in them a program module executing program commands for generating a digital code which is displayed on the display panel and contains address and/or identification data and/or current messages of the machine. Implemented in a mobile digital reading device having a camera, a data processor, a data memory and a wireless communication link installing mechanism is an application program capable of executing program commands for installing a communication link to a digital communications device remote from the machine and for transmitting a digital code captured by the camera or. code information converted into machine-readable data to the remote communications device.

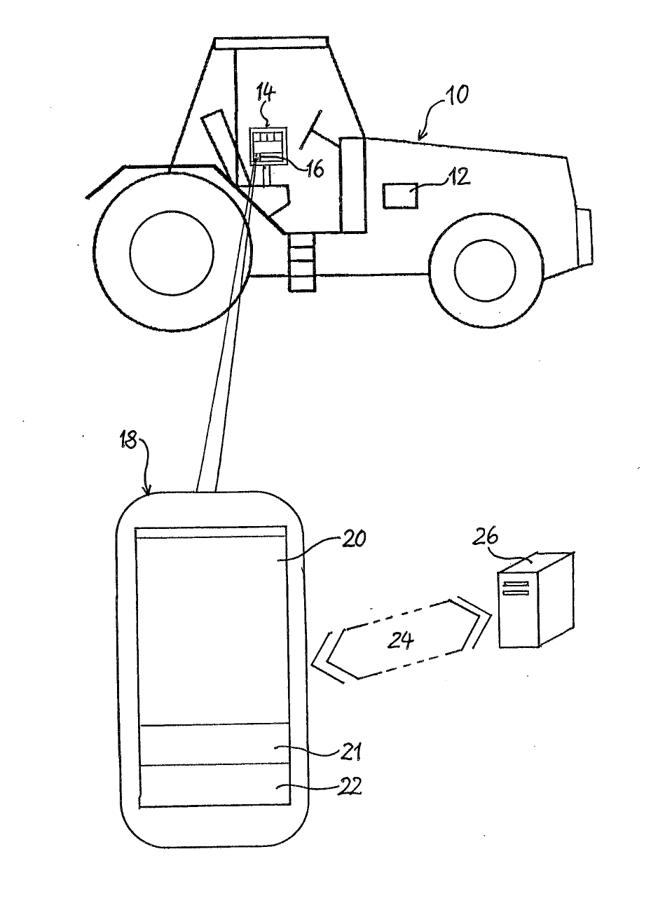

### CROSS REFERENCE TO RELATED APPLICATIONS

Applicants claim priority under 35 U.S.C. §119 of German Application No. 10 2013 109 444.9 filed Aug. 30, 2013.

### FIELD OF THE INVENTION

This invention relates to a system for providing machine-specific information on a mobile machine which includes a programmable electronic control device with a user interface having means for command input and a graphic display panel.

### BACKGROUND OF THE INVENTION

Mobile machines within the meaning of the invention are motorized vehicles, construction machinery, machinery for agriculture and forestry and associated attachments. Mobile machines are nowadays frequently equipped with a programmable electronic control device for open- and closed-loop control of a variety of drive and device components. The control device is connected to actors and, where applicable, attached devices via the machine's own network or control bus system and includes a user interface for entering or selecting control commands and control parameters. The user interface allows the input of desired values for specific parameters and possesses a graphic display panel for display of desired values entered, operating parameters measured by sensors, and function signals of the machine. The display panel is frequently equipped with a touchscreen function to facilitate the input of various parameters. Agricultural vehicles and mobile agricultural machines frequently employ control bus systems and user interfaces in conformity to ISO 11783 standard.

With the current trend towards elaborate and sophisticated designs of mobile machines, a recurring problem is that failures or malfunctions have to be corrected or repair work needs to be done on site, all of which require detailed information to describe design features, functions and error sources. Hardware constraints of the existing and standardized control devices and user interfaces allow only very rudimentary machine-specific information to be stored there. Therefore, a machine user as a rule has to rely on printed manuals with all their advantages and disadvantages. For customer support by telephone, it is necessary for the customer to first know and provide specific parameters such as serial number, version number, date of manufacture, etc. Because of the long columns of figures customarily involved, this takes a lot of time which in critical situations, as during crop harvesting, is often not available.

### SUMMARY OF THE INVENTION

It is an object of the present invention to make available to the user or operator of a mobile machine machine-specific information for general assistance, for correcting a malfunction or for repair or maintenance, in particular on site, in a straightforward and fast manner.

According to the present invention, this object is accomplished by a system for the supply of machine-specific information to a mobile machine which includes a programmable electronic control device and an associated user interface comprising means for command input and a graphic display panel, the electronic control device and/or the user interface have implemented in them a program module executing program commands for generating a digital code which is displayed on the display panel and contains address and identification data and/or messages of the machine.

The program module for generating a digital code may be implemented in the control device and/or the user interface by the manufacturer, requiring only little implementation effort and memory space. In addition to the machine data relevant for service support, the program module is also able to convert messages available on the user interface, for example, error messages, into a digital code readable on the display panel. There is no need for an additional interface for the transmission of such information.

The system of the invention comprises in a first variant a mobile digital reading device including a camera, a data processor, a data memory, an electronic display panel and an application program configured to use the code information to select from a data base stored in the data memory and containing machine-specific information, items of information allocated to the code information and to display them on the electronic display panel. This variant has the advantage that the machine user, upon reading the code displayed on the user interface by means of the reading device, is able to obtain specific information on the electronic display panel of the reading device promptly, and this even in cases where communication to a server is not possible.

The system of the invention comprises in a second variant a mobile digital reading device including a camera, a data processor, a data memory and means for installing a wireless communication link, wherein the reading device has implemented in it an application program capable of executing program commands for the installation of a communication link to a digital communications device remote from the machine and of transmitting digital information, such as a digital code captured by the camera or code information, to the remote communications device.

Using this mobile reading device and the implemented application program, the machine user may read the generated digital code from the display panel of the user interface and send it promptly and reliably to the machine manufacturer or a service station via the wireless communication link installed by the reading device, so that all the information necessary for support are available there equally promptly and reliably.

Preferably, the application program of the reading device is configured to be able to convert the captured digital code into a machine-readable format conventionally used in order to then transmit the converted code information. In this case, the recipient of the code information needs no converter software of his own, but receives all the data directly in the usual machine-readable format.

Preferably, the reading device of the second variant is equally provided with an electronic display panel for display of the information sent, for example, by the machine manufacturer or a service point to enable the user to rectify a fault.

The system of the invention has the advantage that, dispensing with the need to install an additional interface, it enables machine-relevant data to be captured on the mobile machine and forwarded automatically, without requiring a person to act as intermediary in the data transport. Data transmission errors and delays thereby incurred and human errors are avoided in this manner.

In a preferred embodiment, the program module generates a two-dimensional QR code (Quick Response code). The programs for the generation of QR codes are advantageously lean and require little memory space. In addition, they integrate readily into the standardized programs of the control device and user interfaces of mobile machines, in particular those conforming to ISO 11783 standard.

As reading devices, smartphones or tablet computers are preferably taken into consideration. The display panels of these devices enable machine-specific service information to be displayed also in image or multimedia format.

According to the invention, the code information may contain a machine manufacturer's address or a service station authorized by the machine manufacturer, including, for example, an internet address accessible by the application program of the reading device, to enable the reading device to install automatically a communication link to a communications device allocated to the address. In this manner, after the code captured on the machine has been read and converted by means of the reading device, any necessary service information can be retrieved automatically and loaded, as the case may be.

According to another proposal of the invention, the application program of the reading device may be linked to an address data base and configured to use the code information for selecting from the address data base one or more addresses of data bases containing machine-specific information allocated to the code information. The address data base linked to the application program may then be updated. A permanent update of information stored on the machine is therefore not necessary. The address data base may be stored in the reading device or in a remote server accessible to the reading device by means of a communication link.

### DESCRIPTION OF THE DRAWINGS

An embodiment of the present invention will be explained in more detail in the following with reference to the accompanying drawing. The drawing shows schematically by way of example an agricultural tractor 10 equipped with a programmable electronic control device 12. The control device 12 allows various modes of operation of the tractor 10 and a control of implements adapted to be coupled to the tractor 10. Via a bus system installed in the tractor 10, the control device 12 is linked to a user interface 14 which may be configured in conformity to ISO 11783 standard and includes an electronic digital display panel. The display panel comprises a touchscreen with selectable input fields for editing values and selecting displayed work symbols which serve as program-defined keys. Vehicle data, sensor messages and other data may be displayed on sections of the display that are not used for the input of commands.

Implemented in the control device 12 or the user interface 14 is a program module which in the event of a malfunction, maintenance need or on demand generates a two-dimensional QR code 16 and displays it on the display panel of the user interface 14. The QR code 16 contains data for accurate identification of the tractor 10, its technical features, and it may also contain data and features of attachment devices, if any. Furthermore, the QR code 16 may also contain current news relating to the mode of operation and measurement results supplied by sensors.

The user who has available a camera-enabled mobile digital reading device 18, for example, a smartphone, may capture the QR code 16 displayed on the display panel of the user interface 14 and store it as an image file.

The digital reading device 18 possesses a data processor and an electronic display panel 20 with touchscreen input fields and includes a device for installation of a wireless communication link according to conventional standards and protocols. The reading device 18 further includes an installed application program capable of converting the QR code 16 into a machine-readable file and storing it. Allocated to the application program is an address data base containing telecommunication or internet addresses of manufacturers or service stations which are retrievable by means of the telecommunications device of the reading device 18 and are able to provide specific information relating to the tractor 10. The address data base may be stored in the reading device 18 or in a remote digital device allocated to the reading device 18, for example, a server accessible by the application program of the reading device 18 by means of the telecommunications device and the stored address.

The application program selects addresses from the address data base which are allocated to the information of the QR code 16, and displays them on the display panel 20, for example in fields 21, 22. By touching a selected field 21 or 22, the program causes a communication link 24 to be established to a digital device allocated to the selected address, for example, a server 26, and transmits to it the machine-readable code information. Based on such data, the program of the server 26 is then able to compile pertinent, machine-specific information from data bases accessible to the server 26 and transmit it through the communication link 24 to the reading device 18 where the information received may be displayed on the display panel 20 in text, image or multimedia format.

The system described is capable of providing fast assistance to users of mobile machines and implements in the event of problems and malfunctions so that down times and costs thereby incurred may be reduced. Requiring no additional hardware, the system may be implemented using the digital devices customarily available on the machine and to the user by installation of the programs provided for this purpose. Troubleshooting is more effective and in consequence faster because up-to-date machine information can be captured to be included in the selection of information for troubleshooting.

What is claimed is:

1. A system for providing machine-specific information on a mobile machine which includes a programmable electronic control device and an associated user interface comprising means for command input and a graphic display panel, said control device and/or said user interface having implemented in them a program module executing program commands for generating a digital code which is displayed on the display panel and contains address and/or identification data and/or current messages of the machine.

2. The system according to claim 1 comprising a mobile digital reading device including a camera, a data processor, a data memory, an electronic display panel and an application program configured to use the code information to select from a data base stored in the data memory and containing machine-specific information, items of information allocated to the code information and to display them on the electronic display panel.

3. The system according to claim 1 comprising a mobile digital reading device including a camera, a data processor, a data memory and means for installing a wireless communication link, said reading device having implemented in it an application program capable of executing program commands for the installation of a communication link to a digital communications device remote from the machine and of transmitting digital information, such as a digital code captured by the camera or code information converted into machine-readable data, to the remote communications device.

4. The system according to claim 2, wherein the application program of the reading device is capable of executing program commands for converting a digital code into machine-readable data conventionally used and for storing the converted code information.

5. The system according to claim 3, wherein the remote digital communications device includes a data processor, a data memory and a program capable of executing program commands for storing and converting the digital code into machine-readable data conventionally used and for storing the converted code information.

6. The system according to claim 2, wherein the application program of the reading device or of a remote first digital communications device, when being executed, is capable of accessing at least one address retrievable from, or identifiable by, the converted code information.

7. The system according to claim 3, wherein the application program is configured to use the converted code information to select an address from an address data base allocated to the application program and containing addresses of data bases supplying machine-specific data.

8. The system according to claim 3, wherein the reading device is provided with an electronic display panel.

9. The system according to claim 2, wherein the reading device is a smartphone or a tablet computer.

10. The system according to claim 1, wherein the user interface is a virtual terminal conforming to ISO 11783 standard in the cab of a farm tractor or agricultural machinery.

11. The system according to claim 1, wherein the program module comprises commands for the conversion of data present on the user interface into a QR code.

12. A method for providing machine-specific information on a mobile machine which includes a programmable electronic control device with a user interface having means for command input and a graphic display panel, comprising the steps of:
generating a visual digital code containing address and/or identification data and/or current messages of the machine by means of a program module implemented in the control device and/or the user interface,
displaying the visual digital code on the display panel of the user interface,
reading and storing the digital code displayed by means of a mobile digital reading device including a camera, a data processor, a data memory and an electronic display panel, and
converting the digital code read by means of an application program implemented in the reading device and storing the converted code information.

13. The method according to claim 12, comprising selecting, by means of the code information, machine-specific items of information allocated to the code information from a data base stored in the data memory of the reading device and containing machine-specific information, and displaying the machine-specific information items on the electronic display panel.

14. The method according to claim 12, comprising transmitting the converted code information by means of a wireless communication link from the reading device to a remote digital communications device of a data base installed to supply machine-specific information allocated to the converted code information, and
loading machine-specific information from the data base to the reading device and displaying the machine-specific information on the electronic display panel of the reading device.
